(19) United States
(12) Patent Application Publication
(10) Pub. No.: US 2018/0016883 A1
(43) Pub. Date: Jan. 18, 2018

(54) ENHANCED OIL RECOVERY AND ENVIRONMENTAL REMEDIATION

(71) Applicant: STATOIL PETROLEUM AS, Stavanger (NO)

(72) Inventors: Ane KJØLHAMAR, Trondheim (NO); Anita SKARSTAD, Trondheim (NO)

(73) Assignee: STATOIL PETROLEUM AS, Stavanger (NO)

(21) Appl. No.: 15/546,816

(22) PCT Filed: Jan. 27, 2016
(86) PCT No.: PCT/NO2016/050012

§ 371 Date: Jul. 27, 2017

(30) Foreign Application Priority Data
Jan. 28, 2015 (GB) 1501408.7

(51) Int. Cl. E21B 43/16; B09C 1/10; C09K 8/582; C09K 8/584; C12R 1/01; E21B 43/24

(52) U.S. Cl. CPC E21B 43/16; C09K 8/584; C12R 1/01; B09C 1/10; C09K 8/582; E21B 43/24

(57) ABSTRACT

The invention provides an isolated bacterial strain selected from the group of bacterial strains deposited under accession number ECACC 15010609; ECACC 15010601; ECACC 15010602; ECACC 15010603; ECACC 15010604; ECACC 15010605; ECACC 15010606; ECACC 15010607; ECACC 15010608; and a bacterial strain having all the identifying characteristics of one or more of the strains. The use of said bacterial strains in a method of treating an oil reservoir, a method of bioremediation and a method for the production of a biosurfactant-like substance is also provided. The invention still further provides a biosurfactant-like substance so obtained and the use thereof in method of enhanced oil recovery (EOR) and a method of environmental remediation.

The present invention relates generally to the fields of enhanced oil recovery (EOR) and environmental remediation and the production and use of material having biosurfactant-like properties. More specifically the present invention provides 9 novel bacterial isolates that have been identified as having a specific combination of properties which make them especially suited to use in microbial enhanced oil recovery (MEOR) applications, including the ability to produce compositions having biosurfactant-like properties upon contact with a hydrocarbon substrate under conditions representative of an in situ oil reservoir. The use of such compositions specifically in EOR and bioremediation but also more generally as replacements for chemically synthesised surfactants is provided.

Much of the world's oil reserves are located below the surface of the earth in voids within bodies of reservoir rocks. In these contexts, the natural pressure of an untapped reservoir will be sufficient to drive some of the oil to the head of a bore hole introduced into the reservoir. This pressure may be provided by natural underground aquifers and/or the release of gas dissolved in the reservoir. As the volume of the oil in the reservoir is reduced the pressure drops and eventually reaches a point that is insufficient to drive oil to the surface. This is the point that primary production ceases. To achieve further recovery of oil secondary production processes are employed. Such processes involve the injection of gas and/or water into the reservoir to increase pressure in the reservoir which thereby drives oil to the surface. As the volume of oil in the reservoir is further depleted, the amount of injected fluids which return with the oil increases and eventually the process becomes uneconomical. This is the point at which secondary production ceases. After the cessation of secondary production the field may be abandoned or tertiary production techniques may be brought to bear. This may be referred to as Enhanced Oil Recovery (EOR). In other instances the reservoir rock and/or the oil which is contained therein is so difficult to extract that EOR techniques are applied from the outset or during secondary production.

Numerous EOR techniques are available, but the common principle embodied by each is the modification of the properties of the reservoir fluids and/or the reservoir rock characteristics in order to facilitate the movement of the oil from the reservoir to the point of collection, e.g. to the surface. Typically this involves reducing interfacial tensions between the oil and the displacing fluid and the oil and the surrounding rock interfaces, reducing oil viscosity, increasing the viscosity of the displacing fluid, creating miscible displacement, selectively plugging overly porous rock and increasing the porosity of less porous rock.

Reduction in interfacial tensions may be achieved with surfactants or alkaline chemicals which react with the organic acids in the oil to form surfactants in situ. Reducing viscosity is typically achieved by thermal means, e.g. steam flooding and in situ combustion or by dissolving gas in the oil or selectively degrading long-chain saturated hydrocarbons. Increasing the viscosity of the displacing fluid may be achieved with soluble polymers, e.g. biopolymers. Miscible displacement involves solubilising the oil in a solvent, e.g. liquid organic solvents or gases, to form a continuous homogenous phase and recovering that mixture. Selective plugging may be achieved with polymeric materials including biopolymers and microbes and rock porosity may be increased by introducing degradative chemicals, e.g. acids or alkalis, which react with the reservoir rock.

Microbial enhanced oil recovery (MEOR) defines an EOR approach which employs microbes to achieve the desired physical effects on the oil reservoir. In particular, microbes capable of producing biosurfactants may be used to produce and deliver in situ the surfactant intended to reduce interfacial tensions; microbes capable of producing solvent gases may be used to produce and deliver in situ the gases intended to solubilise the oil; microbes capable of degrading long-chain saturated hydrocarbons may be used to lower oil viscosity; acid producing microbes may be used to produce and deliver in situ the acids intended to increase porosity and/or react with the oil to create surfactants; and microbes capable of producing and delivering plugging biopolymers in situ may be used to plug overly porous rock.

It can readily be seen that the principles underlying EOR (including MEOR), i.e. recovery of hydrocarbons from a site in the natural environment, may be shared by techniques for the remediation of polluted, e.g. hydrocarbon polluted, natural and man-made environments and for the recovery of heavy hydrocarbons, e.g. oil and bitumen (asphalt), from mined hydrocarbon-impregnated sedimentary rock (so called oil- or tar-sands), which may be considered an oil reservoir in its own right and to which EOR techniques may be applied. Consequently some EOR techniques may be translated to the remediation of polluted, e.g. hydrocarbon polluted, natural and man-made environments and to the recovery of heavy hydrocarbons from mined hydrocarbon-impregnated sedimentary rock.

Environmental remediation refers to the removal or neutralisation of pollution or contaminants, e.g. hydrocarbons, from environmental media, e.g. soil, groundwater, sea water or surface water or man-made environments. Bioremediation refers to the use of organisms, e.g. microorganisms, to achieve this end. Remediation technologies can be generally classified as in situ or ex situ. In situ remediation involves treating the contaminated site or location, while ex situ involves the removal of the contaminated material to be treated elsewhere.

Certain remediation techniques to address hydrocarbon contamination, e.g. oil spills, involve the application of surfactants to the hydrocarbon as a means of dispersion and to increase bioavailability. In particular is the technique of surfactant enhanced aquifer remediation (SEAR) in which surfactants are injected into the subsurface to enhance desorption and recovery of non-aqueous phase liquid. Some surfactants, especially biosurfactants, have also been observed to facilitate remediation of heavy metal, e.g. cadmium, copper, lead and zinc, contaminated sites. Other techniques involve the application of microorganisms that may consume, solubilise and/or aid the dispersion and bioavailability of the contaminants, e.g. by producing biosurfactants from hydrocarbons.

The recovery of heavy hydrocarbons from mined hydrocarbon-impregnated sedimentary rock can be achieved by the EOR techniques described above, in particular, approaches in which surfactants, e.g. biosufactants, are used to separate heavy hydrocarbons from hydrocarbon-impregnated sedimentary rock on account of the surface activity and/or emulsifying properties of the surfactant. Another notable approach is a process termed “hot solvent extraction”, a form of miscible displacement. Hot solvent extraction involves vapour injection of organic solvents into the hydrocarbon impregnated rock and as such is energy intensive. Lower temperatures may be used when a bioconverting microorganism is employed in the process as the microorganism can take advantage of the effects of the solvent on internal structure of the hydrocarbon-containing rock thereby gaining access to the interior of the rock substrate and the exerting its biosurfactant-like effects on the substrate and facilitating the separation of the hydrocarbon from the rock.

Biosurfactants are a class of structurally-diverse, highly surface-active compounds synthesised by microorganisms. These compounds are surface-active on account of having hydrophilic and hydrophobic domains and include glycolipids, phospholipids, fatty acids, lipopeptides/lipoproteins and non-lipid polymers. Biosurfactants are characterised by a lack of toxicity and susceptibility to biodegradation and so are attractive replacements for chemically synthesised surfactants that are notable for their toxicity and persistence in the environment. Indeed, the biodegradable nature of biosurfactants make them especially attractive for environmental use, e.g. in EOR and environmental remediation.

The inventors have now identified a group of 9 bacterial isolates that each have a specific combination of properties which make them especially suited to use in microbial enhanced oil recovery (MEOR) applications and bioremediation applications, including the ability to grow on and produce compositions having biosurfactant-like properties from a crude oil substrate under conditions of pH, pressure, temperature, osmolality and oxygen concentration representative of an in situ subterranean oil reservoir. These properties are detailed in the Examples. The closest species matches are Geobacillius toebii, Aeribacillus pallidus and Anoxybacillus beppuenis, as determined by comparison of 16S rDNA sequences, however these isolates are not genetically identical to these species matches and show phenotypic variation amongst themselves.

Thus in a first aspect of the invention there is provided an isolated bacterial strain selected from the group of bacterial strains consisting of:
(i) the bacterial strain deposited under accession number ECACC 15010601;
(ii) the bacterial strain deposited under accession number ECACC 15010602;
(iii) the bacterial strain deposited under accession number ECACC 15010603;
(iv) the bacterial strain deposited under accession number ECACC 15010604;
(v) the bacterial strain deposited under accession number ECACC 15010605;
(vi) the bacterial strain deposited under accession number ECACC 15010606;
(vii) the bacterial strain deposited under accession number ECACC 15010607;
(viii) the bacterial strain deposited under accession number ECACC 15010608;
(ix) the bacterial strain deposited under accession number ECACC 15010609; and
(x) a bacterial strain having all the identifying characteristics of one or more of strains (i) to (ix).

The ECACC is the European Collection of Authenticated Cell Cultures having its address at Public Health England, Culture Collections, Porton Down, Salisbury, Wiltshire SP4 0JG, United Kingdom. Each deposit was made with the ECACC under the Budapest Treaty on 6 Jan. 2015 and confirmed as viable.

By “isolated” it is meant that the bacterial strain is not in contact with the components of its natural environment, i.e. the environment from which it was originally taken. More specifically, an isolated strain of the invention is not in contact with the hydrocarbon-containing substrate from which it was taken and/or is not in contact with other microbes, e.g. bacteria, from the environment from which it was taken. Most populations of the bacterial strains of the invention will have been produced by means of a technical process, e.g. cultured, and not themselves taken from a natural environment, these are inherently “isolated” in the sense of being free from any natural environment or state.

Thus, this aspect of the invention also provides a biologically pure culture of a bacterial strain selected from the abovementioned group of bacterial strains. A biologically pure culture may be considered as being substantially, preferably essentially, and most preferably completely, free of other intact cells, microbial or otherwise. Numerically this may be expressed as a culture in which at least 90%, preferably at least 95%, 98%, 99% or 99.5%, of the cells present therein are those of a selected bacterial strain of the invention. The above isolated strains will preferably be biologically pure cultures.

“Bacterial strains having all the identifying characteristics” of the deposited strains will include descendants and mutants of said strains. It is recognised that minor genotypic changes in such descendants and mutants may not be reflected in phenotypic changes and that some minor phenotypic changes in such descendants and mutants will be irrelevant, in particular irrelevant in terms of the ability to produce a biosurfactant-like substance from an oil substrate under downhole conditions, and consequently such descendants and mutants would, in the context of the present invention, be functionally equivalent to the deposited strains. “Identifying characteristics” will be understood with this purpose in mind. More specifically, identifying characteristics include at least one, e.g. at least 2, 3, 4, 5, 8, 10 or all of the characteristics listed in Table 8, in particular one or more or all of those relating to heavy oil use, pH, salt, temperature and anaerobic (anoxic) growth.

It may be advantageous to use an isolated strain of the invention in combination with another strain from the above-mentioned group. Without wishing to be bound by theory, by using two or more of the isolated strains of the invention in combination the skilled man can select a consortium of strains that are optimised for his needs, e.g. the particular conditions (oil type, pH, temperature, salt concentration, pressure, oxygen levels, etc.) of a target oil reservoir. This may be due to the production of a biosurfactant-like substance of particular and advantageous properties. It is further considered possible that particular combinations of the strains of the invention will act synergistically in certain technical applications and contexts. The relative proportions of each strain used together may be same or different. By varying the proportions as well as the identity of strains in the consortium greater control over the proprieties of the consortium may be achieved.

Thus, in another aspect there is provided a combined preparation of bacterial strains, said preparation comprising two or more bacterial strains, preferably 3 or 4, even 5, 6, 7, 8 or more bacterial strains selected from the group defined above.

In preferred embodiments said preparation comprises at least ECACC 15010601, ECACC 15010602, ECACC 15010603, and ECACC 15010609 and optionally one or more of strains (iv)-(viii) or (x).

In further embodiments said preparation comprises at least ECACC 15010601, ECACC 15010602, and ECACC 15010609 and optionally one or more of strains (iii)-(viii) or (x).

In further embodiments said preparation comprises at least ECACC 15010601, ECACC 15010602, ECACC 15010603, and ECACC 15010604 and optionally one or more of strains (v) to (x).

In further embodiments said preparation comprises at least ECACC 15010601 and ECACC 15010602 and optionally one or more of strains (iii)-(x).

In further embodiments said preparation comprises at least ECACC 15010601, ECACC 15010602 and ECACC 15010603 and optionally one or more of strains (iv)-(x).

In further embodiments said preparation comprises at least ECACC 15010601 and ECACC 15010609 and optionally one or more of strains (iii)-(viii) or (x).

In further embodiments said preparation comprises at least ECACC 15010601 and ECACC 15010609 and optionally one or more of strains (ii)-(viii) or (x).

The various components of the combined preparations of the invention may be provided as a single entity, e.g. combined as a mixture or blend, or separately or some separately and others mixed. If one or more component is provided separate to the others, a plurality of containers or a single containers with discrete compartments will be typically be used. Preferably the different bacterial strains will be provided separated from each other.

The isolated bacterial strains and the bacterial strains of the combined preparations of the invention may be provided in any convenient physical form. Within such forms the bacteria may be dormant (e.g. in spore form), stationary or growing. For instance, the bacteria may be provided as a suspension of cells or a pellet of cells in a liquid acceptable to said bacteria, e.g. water, a culture medium (e.g. lysogeny broth, DMEM, MEM, RPMI, MMAcYE (minimal medium, acetate, yeast extract)) a buffer (e.g. PBS, Tris-buffered saline, HEPES-buffered saline) or a, preferably isotonic or hypertonic, salt solution (e.g. brine). In certain embodiments the liquid is a liquid suitable for cryopreservation (e.g. a cryoprotectant), for instance, glycerol and/or DMSO. The bacteria may also be provided in dried form, e.g. lyophilised. In such embodiments the bacteria may be present together with one or more lyophilisation excipients, e.g. salts (organic and inorganic), amino acids and carbohydrates (mono-, di-, oligo- and polysaccharides).

Thus in a further aspect there is provided a composition comprising one or more isolated bacterial strains, preferably 2, 3, 4, 5, 6, 7, 8 or more isolated strains selected from the group consisting of:
(i) the bacterial strain deposited under accession number ECACC 15010601;
(ii) the bacterial strain deposited under accession number ECACC 15010602;
(iii) the bacterial strain deposited under accession number ECACC 15010603;
(iv) the bacterial strain deposited under accession number ECACC 15010604;
(v) the bacterial strain deposited under accession number ECACC 15010605;
(vi) the bacterial strain deposited under accession number ECACC 15010606;
(vii) the bacterial strain deposited under accession number ECACC 15010607;
(viii) the bacterial strain deposited under accession number ECACC 15010608;
(ix) the bacterial strain deposited under accession number ECACC 15010609; and
(x) a bacterial strain having all the identifying characteristics of one or more of strains (i) to (ix).

For instance, the composition may comprise the particular combinations of strains recited above.

The combined preparations and compositions of the invention may also comprise further microbes, e.g. bacteria, preferably microbes that may have utility in MEOR or bioremediation applications, e.g. those which degrade hydrocarbons and assimilate heavy metals and/or which produce compositions of utility in EOR or environmental remediation, e.g. biosurfactants, acids, alkalis, biopolymers and solvent gases. In other examples microbes which improve the activity of the bacteria of the invention, e.g. by providing essential nutrients, may be provided.

The physical form of the composition and examples of appropriate carriers are disclosed herein. At its simplest the composition may amount to a bacterial population of the invention in water, preferably buffered water or an iso- or hypertonic salt solution. In certain embodiments the composition is substantially, preferably essentially, most preferably completely free of the hydrocarbon-containing substrate from which the constituent bacteria were isolated. Numerically this may be expressed as a composition in which less than 10% (w/w, v/v, w/v or v/w as appropriate), preferably less than 5%, 2%, 1%, 0.5% or 0.1%, is the hydrocarbon-based substrate from which the constituent bacterium was isolated.

The compositions and combined bacterial preparations of the invention may be provided with further components, in particular, components to facilitate the use of the bacteria of the invention (e.g. growth media, oil reservoir delivery vehicles, essential nutrients and growth supplements) and/or components of use alongside the bacteria in the MEOR and bioremediation methods of the invention (e.g., EOR chemicals, oil well treatment chemicals and remediation chemicals). In these latter embodiments the compositions may be described as MEOR compositions and/or bioremediation compositions.

Notable nutrients and growth supplements include, but are not limited to, carbohydrate sources (e.g. molasses, corn syrup), amino acid sources (e.g. tryptone, peptone, yeast extract, beef extract, serum, blood, casamino acids), acetate, salts of potassium, calcium and phosphorous and the hydrocarbon(s) present at the target treatment site.

Notable oil well treatment chemicals include, but are not limited to, scale inhibitors (e.g. inorganic and organic phosphonates (e. g. sodium am inotrismethylenephosphonate), polyaminocarboxylic acids or copolymers thereof, polyacrylamines, polycarboxylic acids, polysulphonic acids, phosphate esters, inorganic phosphates, polyacrylic acids, inulins (e. g. sodium carboxymethyl inulin), phytic acid and derivatives (especially carboxylic derivatives) thereof, polyaspartates); hydrate inhibitors (e.g. methanol, mono-ethylene glycol); asphaltene inhibitors; wax inhibitors; corrosion inhibitors (e.g. polyaspartates); anti-freeze molecules (e.g. alcohols and glycerols) and biosurfactants.

Notable EOR chemicals include, but are not limited to, acids, alkalis, biopolymers and surfactants (including biosurfactants).

Notable oil reservoir delivery vehicles include, but are not limited to, hydrocarbons or hydrocarbon mixtures, typically a C₃ to C₁₅, e.g. a C₃ to C₆ or a C₃ to C₉ hydrocarbon, or oil, e.g. crude oil; or aqueous salt solutions, e.g. synthetic brine, or seawater. Salt solutions or simply water are preferred in EOR and environmental remediation contexts.

Notable remediation chemicals include, but are not limited to acidic aqueous solutions, basic aqueous solutions, chelating or complexing agents, reducing agents, organic solvents and surfactants, including biosurfactants.

The bacteria of the invention may be provided immobilised on a solid support. Such supports may be in the macroscopic scale, e.g. agar, agarose, alginate, pectin, gelatin, hyaluronan or other hydrogel containing plates and vessels, but preferably in the microscopic scale, e.g. particulate solid supports (for instance beads, pellets and microspheres now common in molecular biology). Particulate solid supports of use in the present invention may be formed from inorganic (e.g. silicone, silica or alumina) or organic (e.g. polymeric) materials. In large amounts, such particle-immobilised bacteria may further take the macroscopic form of pellets, cakes, columns, packs, and so on.

Solid support bound bacteria form a further specific aspect of the invention.

As discussed above, the 9 novel bacterial strains of the invention have been identified on the basis of a specific combination of properties which make them especially suited to use in MEOR applications. Thus, in a further aspect there is provided a method of MEOR, said method comprising introducing one or more bacterial strains of the invention to an oil reservoir.

In a further aspect there is provided a method of treating an oil reservoir, the method comprising introducing one or more bacterial strains of the invention to said reservoir. Treatment is intended to enhance the capacity for oil recovery from said reservoir.

In accordance with the invention the generality of the term “oil reservoir” is taken to extend to hydrocarbon-impregnated sedimentary rock, in particular hydrocarbon-impregnated sedimentary rock that has been mined from the earth, i.e. hydrocarbon-impregnated sedimentary rock that has been isolated from its natural environment or which may be described as being ex situ, unless specific context dictates otherwise. In these embodiments the hydrocarbon may be present in the form of oil. Introduction of the bacterial strains of the invention to such reservoirs may be viewed as contacting said bacteria with hydrocarbon-impregnated sedimentary rock, especially mined hydrocarbon-impregnated sedimentary rock. In other specific embodiments the reservoir is a subterranean reservoir.

In accordance with the invention the term “oil” defines a petroleum substance, it is an oil which contains long-chain hydrocarbons, i.e. hydrocarbons of 10 or more carbon atoms, e.g. 10, 15, 20 or 25 or more carbon atoms. In certain embodiments the oil is a crude oil, i.e. petroleum in its natural form. The type of oil which may be present in the reservoir is not limited. The oil may be a light oil, a heavy oil (including bitumen/asphalt), or an oil of intermediate weight. Heavy oil may be considered as a crude oil which has an API gravity less than 20°. Light oil may be considered as a crude oil, i.e. which has an API gravity greater than 30°.

The oil reservoir may be a subterranean oil reservoir which has undergone a secondary stage of oil recovery. By “undergone a secondary stage of oil recovery” it is meant that artificial means, e.g. injection of a gas and/or a liquid into the reservoir, have been employed to increase pressure in the reservoir in order to drive oil to the surface. In certain embodiments such techniques have reached the point of economic non-viability. In other embodiments the oil reservoir may still be in a secondary stage of oil recovery, e.g. at the stage of displacement fluid break through or prior to displacement fluid break through.

MEOR is considered to occur if, following introduction of the bacteria of the invention to a reservoir, more oil is produced from that reservoir than would be possible if recovery without use of bacteria (or other EOR technique) was performed instead. This may be expressed numerically as a difference in oil recovery of at least 0.5% of original oil in place (OOIP), e.g. at least 5%, 10%, 15%, or 20% of OOIP and up to about 25% of OOIP.

The amount of bacteria introduced should be sufficient to result in MEOR from the oil reservoir undergoing treatment, preferably a calculated increase (compared to that assumed by secondary production (recovery without the use of another EOR technique)) of at least 0.5%, more preferably at least 2%, most preferably at least 5%, 10%, 15%, or 20% of OOIP and up to about 25% of OOIP.

The bacteria of the invention may be introduced as a combined preparation of bacteria of the invention or a composition of the invention, preferably as a composition/preparation containing an oil reservoir delivery vehicle, e.g. those detailed above. In embodiments in which more than one bacteria of the invention are used, each type may be introduced separately or together as a mixture, preferably as a mixture. Separate introduction may be at substantially the same time or may be greater than 6, 12 or 24 hours apart, e.g. 1, 2, 5 or 10 days apart, typically 3 to 14 days apart. It may be advantageous to administer one or more, or all, of the different bacteria to be used more than once. In further embodiments it may, at certain times, be advantageous to deliver the bacteria in a continuous feed.

Introduction to a subterranean oil reservoir, including multiple introductions, may take place after secondary production has ceased and before tertiary production, or more specifically extraction, begins. In other embodiments introduction may take place during secondary production, e.g. once displacement fluid break through occurs. In still further embodiments introduction may precede any form of oil production/extraction. With the exception of primary production, the extraction of oil typically involves injecting a displacement fluid (e.g. a liquid or gas) into the subterranean oil reservoir in order to increase pressure therein and force the hydrocarbon contents of the reservoir to the surface. Introduction may take place at any point during the injection of fluids into the reservoir, e.g. from the point at which at least 0.10 pore volumes (PV) of fluid has been injected, e.g. at least 0.15, 0.25, 0.50, 0.75 or 1.0 PV of fluid has been injected. Introduction may precede oil extraction, e.g. during primary, secondary or tertiary production, by at least 6, 12 or 24 hours, e.g. at least 1, 2, 5 or 10 days. Alternatively, or additionally, introduction may take place simultaneously with extraction, e.g. during primary, secondary or tertiary production. Thus, the methods of the invention may further comprise a step of extracting oil from the reservoir, at the same time as, or preferably after the step of introducing the bacteria.

It may be advantageous to introduce the bacteria of the invention to the reservoir prior to extraction and then “top up” the levels of one or more bacteria in the reservoir after extraction has begun. In some embodiments this may occur without halting extraction. In other embodiments the repeat introduction may take place during a pause in extraction. At any time the bacteria of the invention can be delivered in a continuous feed.

Components to facilitate the use of the bacteria of the invention, e.g. growth media, essential nutrients, pH buffers and growth supplements, and/or components of use alongside the bacteria in the methods of MEOR, e.g. oil well treatment chemicals or EOR chemicals, may be introduced together with the bacteria, separately but contemporaneously with the bacteria, or entirely separately from the bacteria. It may in certain embodiments be advantageous to introduce growth media, essential nutrients, pH buffers and/or growth supplements prior to introduction of the bacteria.

The objective is to introduce the bacteria of the invention to the oil remaining within the reservoir in such a way that the bacteria can live, and preferably grow, on or in the oil and provide an EOR effect.

Delivery may conveniently be achieved by flooding the reservoir with an oil reservoir delivery vehicle containing the bacteria of the invention. Particularly in the context of a subterranean oil reservoir, flooding may be achieved by introducing the bacteria-containing delivery vehicle to one or more injection holes in the reservoir under sufficient pressure to force the vehicle into the reservoir. The injection hole(s) may be the same or different to those which are used to flood the reservoir with a displacement fluid, preferably the same injection holes are used. In other embodiments the introduction may take place via a producer hole. Suitable delivery vehicles are disclosed above. Conveniently the delivery vehicle may be the same as the displacement fluid, for instance, an aqueous salt solution, e.g. brine or water. In other reservoirs, in particular mined hydrocarbon-impregnated sedimentary rock, delivery may be achieved by combining, e.g. mixing, the substrate of the reservoir with a delivery vehicle containing the bacteria of the invention.

Prior to introduction to the reservoir it will generally be the case that the bacteria of the invention will undergo ex situ culture (i.e. not in the reservoir). This may increase the number of bacteria, prepare the bacteria for introduction and/or condition the bacteria for efficient growth once in situ. Thus, the methods of the invention may further comprise a step prior to the introduction step of culturing one or more bacterial strains of the invention.

The skilled person would be able to design suitable culture conditions for his/her needs, but the inventors have found that achieving a cell density of 5×10⁸ cells/ml to 5×10⁹ cells/ml, e.g. 6×10⁸ to 2×10⁹ cells/ml, 7×10⁸ to 9×10⁸ cells/ml or about 8×10⁸ cells/ml prior to introduction may be advantageous. It may also be advantageous to introduce the bacteria, e.g. at these cell densities, when the bacteria are in the exponential phase, preferably late exponential phase, of their growth curve. Harvesting at these densities and timepoints is thought to provide cells with the maximum capacity to utilise oil (e.g., maximum amount of cells and maximum viability). Similarly, in certain embodiments bacteria in the stationary phase of their growth curve are not used. In embodiments where a plurality of strains are introduced at substantially the same time, the growth of said strains will advantageously be synchronised to ensure each strain is introduced whilst in the same growth phase, e.g. exponential, in particular late exponential.

The culture medium used may be any medium suitable for culturing bacteria, e.g. lysogeny broth, DMEM, MEM, RPMI, and MMAcYE, supplemented with a source of carbohydrates (e.g. glucose, sucrose, molasses, corn syrup), acetate and amino acids (e.g. beef extract, yeast extract, tryptone, peptone, casamino acids).

Preferably the pH of the culture will be maintained at pH 5-10, e.g. 6-9, 7-9, 7-8 or about pH 7.0 (e.g. pH 6.5-7.5, pH 6.8-7.2 or pH 6.9-7.1). Fluctuations outside of the preferred ranges may be tolerated, but for most of the culture period the pH will be at or within preferred range endpoints.

Preferably the temperature of the culture will be maintained at 20-100° C., e.g. 25-90° C., 35-85° C., 40-80° C., 45-60° C., 45-65° C., 45-70° C., 45-80° C., 50-60° C., 50-65° C., 50-70° C., 50-75° C., 50-80° C., 55-60° C., 55-65° C., 55-70° C., 55-75° C., 55-80° C. preferably 55-60° C. Fluctuations outside of the preferred ranges may be tolerated, but for most of the culture period the temperature will be at or within preferred range endpoints.

Preferably the salt concentration of the culture will be maintained at or below 10% w/v, e.g. at or below 8%, 6%, 4%, 3%, 2% or 1% w/v. In certain embodiments the salt concentration in the culture may be negligible to 0% w/v.

The bacteria may be cultured aerobically, anaerobically or in a regime having one or more periods of aerobic culture and one or more periods of anaerobic culture.

The ex situ culturing of the bacterial strains of the invention may take place in any suitable vessel. In preferred embodiments a bioreactor (a system for the growth of cells in culture), preferably of industrial scale, may be used, preferably under the conditions described herein. Suitable bioreactors are available in the art and the skilled person would find such reactors routine to use. Bioreactors may be specially designed to supply nutrients to a living culture of bacteria of the invention under optimum conditions and/or facilitate the removal of products produced by the bacteria, e.g. waste products that may inhibit growth. The bioreactor may be adapted to function in a batch-wise fashion or as a continuous culture, or both.

Exposing the ex situ cultures to the oil of the target reservoir is expected to ensure the bacteria are able to begin metabolising oil in situ in the quickest time. Without wishing to be bound by theory, it seems that this step turns on the mechanism within the bacteria for exploiting the oil as a nutrient and/or the production of a biosurfactant-like substance, in particular the bioconversion of the oil into a biosurfactant-like substance or an element thereof. It may be advantageous to expose the bacteria to the target oil before the target cell density/growth phase is reached. Amounts of target oil which may be included in the ex situ culture media may be varied, but 0.01-0.5% w/v, e.g. 0.02-0.4%, 0.05-0.3%, 0.08-0.2%, or about 0.1% w/v, may be sufficient.

Thus, in a further aspect, the present invention provides a method of culturing the bacterial strains of the invention as defined herein, said method comprising contacting the bacterial strains with oil under conditions which allow the bacteria to grow and to use the oil as a carbon source and/or to produce a biosurfactant-like substance, in particular to bioconvert the oil into a biosurfactant-like substance or an element thereof.

Following introduction to the reservoir, the bacteria will live, preferably grow, on the reservoir oil substrate and produce compounds which contribute to an EOR effect, in particular a biosurfactant-like substance (BLS). It may therefore be advantageous to allow the bacteria to grow in situ thereby increasing in number. As such, following introduction and prior to commencing (or recommencing) extraction, inoculated reservoirs will be allowed to incubate in a so called “shut-in” period.

Preferably incubation will be for a time sufficient to result in MEOR (e.g. as defined above). This may be measured as a biosurfactant-like effect within the reservoir, e.g. a detectable reduction in interfacial tension between the oil and rock interfaces and/or an emulsifying effect on the oil. In practical terms this may be measured ex situ with a sample of reservoir oil and reservoir rock. Alternatively, samples of reservoir fluid may be tested for an increase in surfactant properties, e.g. as shown in Examples 3 and 5, before and during incubation. Alternatively the numbers and/or dissemination (spread) of the bacteria through the reservoir may be monitored using routine molecular biology techniques, e.g. nucleic acid sequence analysis techniques.

In certain embodiments the method of MEOR of the invention may be used before, after or at the same time as other EOR methods, e.g. flooding with chemically synthesised surfactants, flooding with alkaline, flooding with acid, steam flooding, in situ combustion, gas dissolution, degradation of long-chain saturated hydrocarbons, increasing the viscosity of the displacing fluid with soluble polymers, miscible displacement (e.g. hot solvent extraction) and selective plugging with polymeric compounds. If the MEOR method is run concurrently with an EOR method, or if the MEOR method follows an EOR method, it may be necessary to select an EOR method that is compatible with the MEOR methods of the present invention, or take steps to adjust the conditions of the reservoir to those compatible with the MEOR methods of the present invention, e.g. lowering the temperature in the reservoir to about or below 100° C.

In a further aspect, there is provided a method of bioremediation, said method comprising contacting bacterial strains of the invention with a site or location or a material in need of bioremediation.

Sites or locations which may be in need to bioremediation are not restricted, although typically such sites or locations include, but are not limited to, groundwater, aquifers, surface water courses, subsurface water courses, soil, earth and costal and marine environments. Artificial (i.e. man-made) sites and locations may also in be included, e.g. buildings (domestic and industrial) intact, demolished or otherwise and their foundations, refuse dumps (domestic and industrial), transport infrastructure and so on. A material in need or bioremediation is a material present at or taken from such sites or locations.

The contaminant(s) at the site or location or a material in need of bioremediation is also not restricted, but the properties of the bacterial strains of the invention are believed to make them especially suited to the remediation of hydrocarbon (e.g. crude oil, refined petroleum products, PAHs and alkanes) and/or heavy metal contamination.

The bacteria of the invention may be contacted with, conveniently administered to, the site or location or a material in need of bioremediation as a combined preparation of bacterial strains of the invention or a composition of the invention, preferably as an aqueous composition, e.g. those detailed above. In embodiments in which more than one bacterial strain of the invention is used, each type may be contacted with the target undergoing treatment separately or together as a mixture, preferably as a mixture. It may be advantageous to effect contact of one or more, or all, of the different bacteria to be used with the target undergoing treatment more than once. In further embodiments it may, at certain times, be advantageous to effect contact by providing a continuous feed of bacteria and/or contaminated material.

Components to facilitate the use of the bacteria of the invention, e.g. growth media, essential nutrients and growth supplements, and/or components of use alongside the bacteria in the methods of bioremediation, e.g. environmental remediation chemicals (including those disclosed above), may be administered together with the bacteria, separately but contemporaneously with the bacteria or entirely separately to the bacteria.

The objective of the contacting step is to introduce the bacteria of the invention to the site or location or a material in need of bioremediation in such a way that the bacteria can live, and preferably grow, and provide an environmental remediation effect. This may be by consuming the contaminant, by sequestering the contaminant, by producing a compound that assists in the removal of the contaminant, or a combination thereof. Once the bacteria of the invention have been introduced and allowed to act on the target undergoing treatment, natural environmental processes, e.g. the water cycle, tides, wind, biodegradative and photodegradative processes, may be relied upon to effect the reduction in contamination at the treatment site, location or material. In other embodiments, especially in the context of ex situ treatments, the method may comprise a step in which target undergoing treatment is washed, typically with an aqueous vehicle of low environmental impact, e.g. water or an aqueous salt solution, and/or a step in which treated material is isolated/removed. Multiple cycles of contact, washing and/or isolation/removal may occur.

Delivery to the target site, location or material undergoing treatment may conveniently be achieved by flooding or spraying the site or location or the material in need of bioremediation with a delivery vehicle containing the bacteria of the invention, typically an aqueous vehicle of low environmental impact e.g. an aqueous salt solution, or water. Treatment of contaminated materials may take place ex situ in more controlled conditions. In these embodiments the contaminated material may be added to the bacteria of the invention. In the ex situ treatments of the invention the contaminated material may be treated in a bioreactor containing the bacterial strains of the invention, e.g. in a batch or continuous feed process. Bioreactors containing one or more bacterial strains of the invention are a further aspect of the invention.

In this aspect of the invention it may be advantageous to employ the bacteria of the invention together with or immobilised on or in a particulate solid support, e.g. those disclosed above.

Prior to the contacting step it will generally be the case that the bacteria of the invention will undergo ex situ culture. This may helpfully increase the number of bacteria to be administered, prepare the bacteria for the process of administration (if any) and/or condition the bacteria for efficient growth once in situ. The above discussion of ex situ culture prior to use in the MEOR methods of the invention applies mutatis mutandis to this aspect of the invention. Particular mention should be made of the advantages of exposing the ex situ culture to a hydrocarbon sample or other contaminants from the site to be treated.

In a further aspect the invention provides the use of one or more bacteria of the invention in a method of MEOR or a method of bioremediation, in particular those disclosed in detail herein.

Without wishing to be bound by theory, one of the key properties of the bacteria of the invention which make them suitable for MEOR and bioremediation is the ability to produce a biosurfactant-like substance (BLS) upon contact with a hydrocarbon substrate, e.g. crude oil, refined petroleum products, PAHs or alkanes. As shown in Example 3, the BLS produced by the bacteria of the invention is able to emulsify hard rock bitumen in distilled water and so the same substance and compositions comprising the same are expected to be able to facilitate EOR and/or environmental remediation in a manner analogous to conventional chemically synthesised surfactants. Indeed, Example 2 shows this ability to facilitate EOR in a laboratory scale model of an subterranean oil reservoir. Thus, the BLS can be used to treat a reservoir without bacteria being present. It is further contemplated that the BLS produced by the bacteria of the invention will have applications in other fields as replacements for chemically synthesised surfactants.

Thus, in a further aspect there is provided a method for the production of a biosurfactant-like substance, said method comprising culturing one or more bacterial strains of the invention in the presence of a hydrocarbon source, preferably a source of alkanes and/or polycyclic aromatic hydrocarbons, e.g. crude oil. After culturing the BLS is present in the supernatant and may be harvested.

As described herein, combinations of the strains of the invention may be used in these aspects of the invention, e.g. those already indicated as preferred. In doing so more a complex BLS may be prepared which has particular and advantageous properties. The selected combination, or subsets thereof, may be cultured together or may be cultured separately. The method of producing a BLS of the invention may therefore comprise a step in which supernatants from a plurality of different cultures, or one or more fractions thereof, are combined to produce a BLS. The relative proportions of each strain cultured together, or the relative proportions of the culture extracts in the combination BLS, may be same or different. By varying the proportions as well as the identity of strains/culture extracts greater control over the proprieties of the BLS may be achieved.

In a further aspect there is provided a biosurfactant-like substance, wherein said substance is obtained or obtainable from the methods described herein.

A “biosurfactant” is a biological (i.e. produced by bacteria, yeasts or fungi) surface active agent which lowers the surface tension and interfacial energy of water, with oil-water emulsifying activity. A “biosurfactant-like substance” as used herein is a biological substance, produced from bacteria, that shares these functional features. It is a substance that may not have been characterised down to its individual molecular constituents but typically contains a mixture of compounds which together and/or individually provide surfactant functionality, e.g. proteins or peptides, fatty acids (e.g. palmitic acid), phalates (diisononyl phthalate), etc. The substance will typically also contain one or more non-biosurfactant compounds, e.g. water.

More specifically the BLS of the invention will have oil-water emulsifying activity, surface/interfacial activity and/or oil displacement activity against at least one hydrocarbon containing substrate (preferably crude oil). Preferably the BLS of the invention will show effects in one or more of the following tests, as detailed in the Examples: oil displacement assay, emulsification capacity index, shake flask test, hydrocarbon emulsification test and drop collapse test.

In certain embodiments surfactant activity is measured at a pH of 5 to 11, e.g. 6 to 10.5, 7 to 10, 8 to 9.5, 9 to 9.5, or about 9.3.

The BLS of the invention will preferably retain activity after heating to about 121° C. for up to 10 min, or about 100° C. for up to 30 min, and after storage at about 4° C. for up to 3 months, freezing (about 0° C. or less) for up to 1 yr, or as a freeze dried composition for up to 3 yrs.

The BLS of the invention will preferably display surfactant activity measured at a pH of 5 to 11 following treatment in water with a pH below pH 5, e.g. pH 4, 3 or 2 or above pH 11, e.g. pH 12 or 13 for up to 30 min.

The step of culturing of the bacteria of the invention in the methods of the invention should be under conditions which allow the bacteria of the invention to produce a BLS.

Culturing of the bacteria takes place in a suitable cell culture medium. The identity of the medium is not restricted except insofar as it is suitable for the culture of bacteria, in particular extremophiles. Such media include, but are not limited to lysogeny broth, DMEM, MEM, RPMI and MMAcYE supplemented with a source of carbohydrates (e.g. glucose, sucrose, molasses, corn syrup), acetate and amino acids (e.g. beef extract, yeast extract, tryptone, peptone casamino acids). Preferably the pH of the culture will be maintained at pH 5-10, e.g. 6-9, 7-9, 7-8 or about pH 7.0 (e.g. pH 6.5-7.5, pH 6.8-7.2 or pH 6.9-7.1). Fluctuations outside of the preferred ranges may be tolerated, but for most of the culture period the pH will be at or within preferred range endpoints.

Preferably the temperature of the culture will be maintained at 20-100° C., e.g. 25-90° C., 35-85° C., 40-80° C., 45-60° C., 45-65° C., 45-70° C., 45-80° C., 50-60° C., 50-65° C., 50-70° C., 50-75° C., 50-80° C., 55-60° C., 55-65° C., 55-70° C., 55-75° C., 55-80° C. preferably 55-60° C. Fluctuations outside of the preferred ranges may be tolerated, but for most of the culture period the temperature will be at or within preferred range endpoints.

Preferably the salt concentration of the culture will be maintained at or below 10% w/v, e.g. at or below 8%, 6%, 4%, 3%, 2% or 1% w/v. In certain embodiments the salt concentration in the culture may be negligible to 0% w/v. The bacteria may be cultured aerobically, anaerobically or in a regime having one or more periods of aerobic culture and one or more periods of anaerobic culture.

In these embodiments relating to the preparation of BLS, it may also be advantageous to culture the bacteria of the invention to a cell density of 5×10⁸ cells/ml to 5×10⁹ cells/ml, e.g. 6×10⁸ to 2×10⁹ cells/ml, 7×10⁸ to 9×10⁸ cells/ml or about 8×10⁸ cells/ml before harvesting. It may also be advantageous to allow the culture to continue at the above cell densities for a period of time prior to harvesting, i.e. to allow the culture to continue for period of time in the stationary phase of its growth curve. The optimum incubation time may be determined by the skilled person without undue burden but it may be at least 6, 12 or 24 hours, e.g. at least 1, 2, 5 or 10 days.

Suitable hydrocarbon sources may be crude or partially refined oil, highly or partially fractionated petroleum products (e.g. petrol, diesel, kerosene, purified alkanes, PAHs) or materials (e.g. soil, water, refuse) contaminated with the same. As can be seen, the type of oil which may be used as a hydrocarbon source is not limited. The oil may be light crude oil, heavy crude oil, or an oil of intermediate weight. Amounts of hydrocarbon which may be included in the culture media may be varied, but 0.01-0.5% w/v, e.g. 0.02-0.4%, 0.05-0.3%, 0.08-0.2%, or about 0.1% w/v, may be sufficient.

The culturing of the bacterial strains of the invention in the production methods of the invention may take place in any suitable vessel. In preferred embodiments a bioreactor (a system for the growth of cells in culture), preferably of industrial scale, may be used, preferably under the above described conditions. Suitable bioreactors are available in the art and the skilled person would find such reactors routine to use. Bioreactors may be specially designed to supply nutrients to a living culture of bacteria of the invention under optimum conditions and/or facilitate the removal of products produced by the bacteria, e.g. waste products that may inhibit growth or BLS production, and/or the BLS containing culture medium. The bioreactor may be adapted to function in a batch-wise fashion or as a continuous culture, or both.

The bacteria of the invention may be cultured on a particulate solid support. In preferred embodiments the BLS is the extracellular medium (supernatant) of the culture and is substantially free of bacterial cells and/or cell debris. Cells and/or cell debris can be removed, e.g. by filtration, chromatography, centrifugation and/or gravitational separation. The production method of the invention therefore may include at least one fractionation step, e.g. a step(s) of filtration, chromatography, centrifugationand/or gravitational separation, to remove at least a portion of the intact cells and/or cell debris from the culture. Filtration, centrifugation and/or gravitational separation are preferred for their convenience. The BLS may be described as cell-free, or at least substantially cell-free, when all, or at least substantially all, intact cells are removed, i.e. fewer than 1000 cells/ml, e.g. fewer than 500, 100, 50 or 10 cells/ml, are present. Free, or at least substantially free, of cell debris means less than 1%, e.g. less than 0.5%, 0.1%, 0.05%, or 0.01%, of the volume of the composition is cell debris.

Alternatively, a product may comprise the BLS and the bacteria which generated it.

In still further embodiments the BLS is a concentrated form of the above preparations, i.e. a portion of the water and/or a non-surfactant fraction has been removed from the fractionated products. This may be by chromatography (e.g. size exclusion, ion exchange, HPLC, hydrophobic interaction chromatography), dialysis, filtration (e.g. ultrafiltration and nanofiltration), precipitation (e.g. with alcohol, e.g. methanol or isopropanol), distillation or evaporation. The production method of the invention therefore may further include at least one concentrating step, e.g. a step(s) of chromatography (e.g. size exclusion, ion exchange, HPLC, hydrophobic interaction chromatography) dialysis, filtration (e.g. ultrafiltration and nanofiltration), precipitation, distillation or evaporation that removes a portion of the water and/or non-surfactant component(s) from the surfactant component(s) or vice versa.

A BLS of the invention may be provided in any convenient form. Liquid forms, e.g. aqueous or organic or a mixture of both, or dried forms, e.g. lyophilised forms, are specifically contemplated. A BLS may be formulated into a composition also comprising additives, e.g. preservatives, stabilisers, antioxidants or colourings. Lyophilised forms may comprise one or more lyophilisation excipients, e.g. salts (organic and inorganic), amino acids and carbohydrates (mono-, di-, oligo- and polysaccharides). Other additives include components of use in methods of EOR, e.g. MEOR, and environmental remediation, e.g. bioremediation, including oil well delivery vehicles, oil well treatment chemicals and remediation chemicals. The above discussion of such components applies mutatis mutandis to these embodiments.

As discussed above, the use of chemically synthesised surfactants and biosurfactants in methods of EOR have been proposed. Thus, in a further aspect there is provided a method of EOR, said method comprising introducing a BLS of the invention as defined herein to an oil reservoir.

The amount of BLS administered should be sufficient to result in EOR from the oil reservoir undergoing treatment. Successful EOR may be defined, for example, in relation to OOIP is discussed above.

The BLS of the invention may be introduced with an oil reservoir delivery vehicle, e.g. those detailed above, in particular, with the displacement fluid being used (e.g. water or aqueous salt solutions). Methods of introduction and delivery are discussed above in relation to use of the bacteria themselves and apply, mutatis mutandis to methods employing a BLS.

As discussed above, the use of chemically synthesised surfactants and biosurfactants in methods of environmental remediation have been proposed. Thus in a further aspect there is provided a method of environmental remediation, said method comprising contacting a BLS of the invention with a site or location or a material in need of environmental remediation.

Preferred methods of environmental remediation and of sites or materials which may be in need of environmental remediation may be the same as described above in connection with bioremediation methods of the invention utilising bacteria.

In a further aspect the invention provides the use of a BLS of the invention in a method of EOR or a method of environmental remediation, in particular those disclosed in detail herein.

Chemically synthesised surfactants have numerous industrial, domestic, agricultural, food science, medical and cosmetic applications, e.g. as emulsifying agents, hydrophilising agents, wetting agents, dewatering agents, dispersion agents and antimicrobial agents. The uses of the BLS compositions of the invention in such fields and as such agents constitute further aspects of the invention.

The invention will now be described by way of non-limiting Examples with reference to the following figures in which:

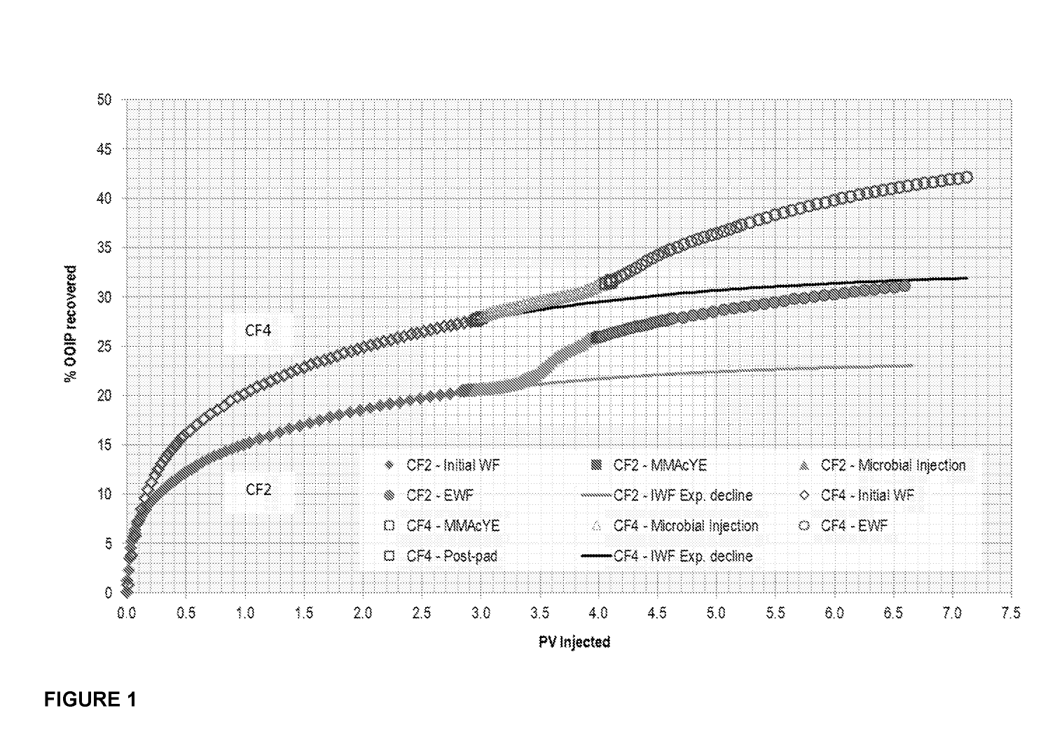

FIG. 1 shows the oil production profiles of two different core flooding experiments as described in Example 1 as a function of percentage of original oil in place versus flooding volume. Key: solid shapes—first experiment (CF2; core flooding number 2); open shapes—second experiment (CF4; core flooding number 4); diamonds—initial water flooding; squares—MMAcYE; triangle—microbial injection; circles—EWF (extended water flooding); solid line—projected recovery.

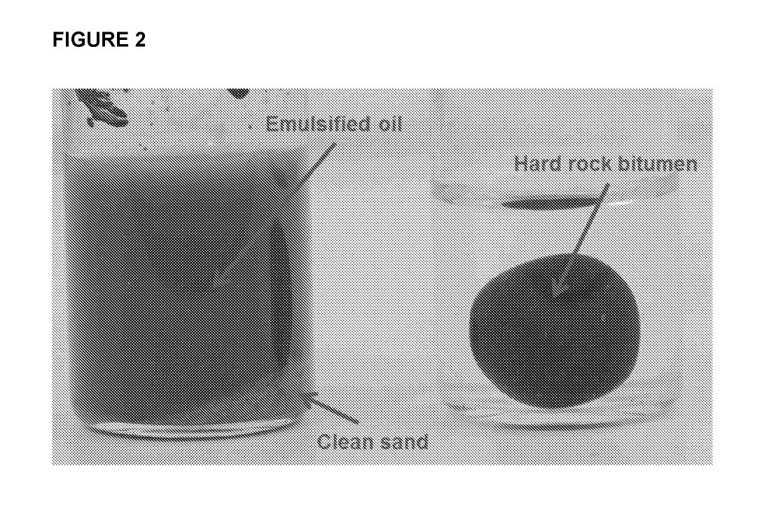

FIG. 2 shows the effects of the BLS of the invention (left hand vessel) and distilled water (right hand vessel) on hard rock bitumen after incubation at 60° C. and 300 rpm for 8 days

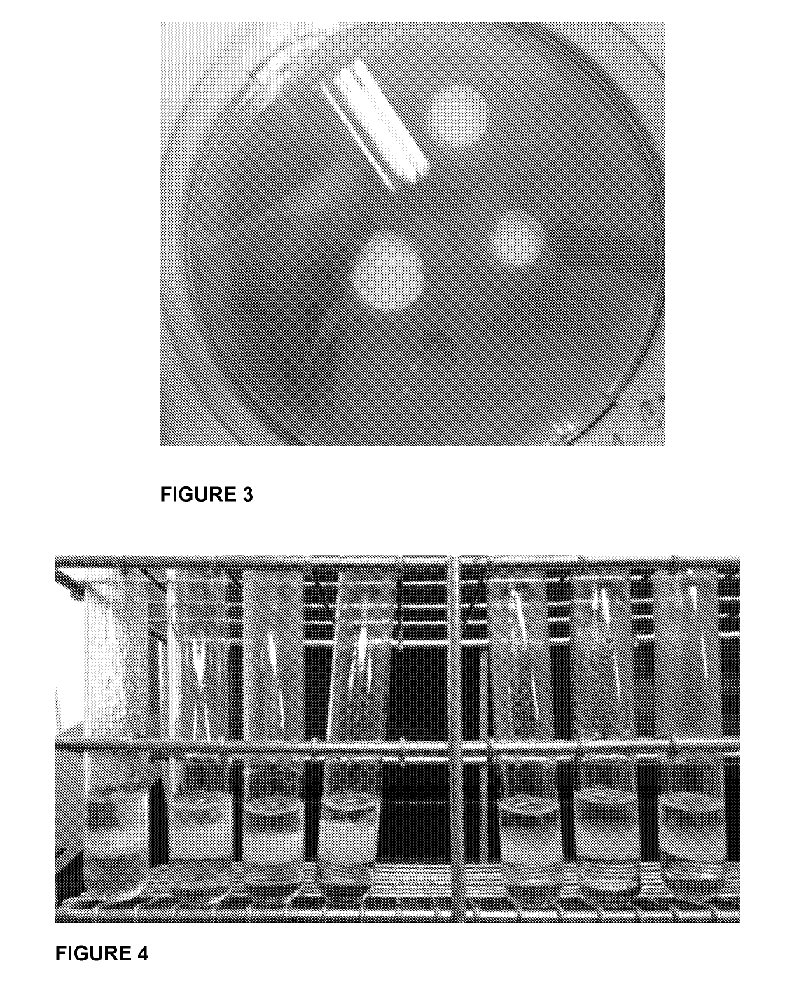

FIG. 3 shows the results of the oil displacement test on BLS prepared in Example 5 using Zuata oil. The diameter of the clear zone is a measure of the oil displacement activity of the BLS.

FIG. 4 shows the results of the emulsification capacity test of on BLS prepared in Example 5 using n-hexadecane. The relative height of the emulsion layer is a measure of emulsification capacity of the BLS. From left: Fermentation 2 batch 1-pH 8.82, batch 1 pH 9.3, batch 2 pH 8.18 and batch 2 pH 9.3, to the right: Fermentation 1 pH 8.84, batch 1 pH 9.3 and batch 2 pH 9.3.

### EXAMPLE 1

### Laboratory-Scale Model of MEOR

### Initial Preparation of Sand Pack and Aging:

Synthetic silica sand of particle size distribution shown in Table 1 was packed into copper sleeves using a wet packing method with vibration. The packed sleeves were tested by applying 60 bar N₂-pressure. The sand-packed sleeves were then installed into an overburden vessel, tri-axially force loaded, dried, evacuated and saturated with synthetic brine. The pore volume was determined during brine imbibition. This method has been extensively used to determine the pore volume of reservoir and synthetic cores and provides accurate data for the volume of fluid that can be held by the tri-axially loaded porous medium.

TABLE 1
Particle size distribution in sandpack

| Microns | Mesh | Clean sieve | After-shake | Mass of | Wt % |
|---|---|---|---|---|---|
| 350 | 45 | 247.61 | 248.63 | 1.02 | 0.51 |
| 250 | 60 | 238.92 | 247.91 | 8.99 | 4.49 |
| 177 | 80 | 231.18 | 264.96 | 33.78 | 16.89 |
| 125 | 120 | 238.87 | 326.38 | 87.52 | 43.76 |
| 105 | 140 | 230.20 | 281.70 | 51.50 | 25.75 |
| 90 | 170 | 226.14 | 238.92 | 12.79 | 6.39 |
| 74 | 200 | 216.15 | 218.62 | 2.48 | 1.24 |
| <74 | pan | 466.11 | 467.77 | 1.66 | 0.83 |

The absolute initial permeability to brine (k_{abs}) was determined by injecting brine at several different flowrates at 60° C. Next, the core assembly was heated to 110° C. and absolute permeability measurements were repeated. The core was then saturated with oil, which was injected at 3 ft/day pore velocity (approximately 1 ft/day Darcy velocity). Approximately 2.8 pore volumes (PV) of oil were injected in all corefloods. Less than 0.5% water cut was observed at the end of oil saturation. Once saturated, cores were aged for approximately 8 days at 110° C. and cooled down to 60° C. prior to initial waterflooding. Effective permeabilities to oil were measured at the end of oil saturation, after ageing (110° C.) and after cooling down to 60° C.

### Secondary Flooding:

Sand pack was flooded with synthetic brine at 60° C. at a flow velocity corresponding to a flux of 33 cm/day (flux: 1×) until water break through. After water break through flux was increased to 2×. Water was changed to Minimum Medium Acetate Yeast Extract (MMAcYE) and allowed to flow for 10-12 hours. Oil was collected as the baseline of the secondary recovery.

### Tertiary Flooding:

Bacteria (SM1 [ECACC 15010601], SM2 [ECACC 15010602], SM3 [ECACC 15010603], and SM14 [ECACC15010609]) were grown separately in MMAcYE plus 0.2% v/v crude oil at 60° C. until exponential phase as monitored by OD 600 measurements. Each culture was synchronised to be in exponential phase at similar times:

### CF2 Run:

For CF2, pure overnight cultures were prepared by inoculating 0.05% v/v SM1,

SM2 or SM3 glycerol stock cultures into 50 ml of MMAcYE contained in a 250 ml baffled flask. Flasks were incubated at 60° C. and 200 rev/min. Overnight cultures (14 hours) were used to inoculate 1% v/v cultures containing crude oil #1 (50 ml MMAcYE+0.2% v/v crude oil). 1% cultures were inoculated and incubated at 60° C. and 200 rev/min. Following incubation for 6 hours (SM3) or 8 hours (SM1 and SM2), cultures were pooled and transferred to the piston cylinder for injection into the core: inoculation of the overnight cultures was staggered to account for the differences in incubation times. Prior to injection for CF2, individual bacterial cultures of SM1, SM2 and SM3 were mixed in a 2:1:1 proportion (volume based).

### CF4 Run:

For CF4, pure overnight cultures were prepared by inoculating 0.05% v/v SM1, SM2, SM3 or SM14 glycerol stock cultures into 50 mL of MMAcYE contained in a 250 mL baffled flask. Flasks were incubated at 60° C. and 275 rev/min. Overnight cultures (14 hours for SM1 and SM2: 16 hours for SM3 and SM14) were used to inoculate 1% v/v cultures containing crude oil #2 (50 ml MMAcYE+0.2% v/v crude oil). 1% cultures were inoculated and incubated at 60° C. and 275 rev/min. Following incubation for 6 hours (SM3 and SM14) or 8 hours (SM1 and SM2), cultures were pooled and transferred to the piston cylinder for injection into the core. For CF4, equal volumes of SM1, SM2, SM3 and SM14 were mixed prior to injection. Total cell counts, pH, OD₆₆₀ and oil displacement tests of individual cultures used for injection were measured for CF4 and are given in Table 2.

TABLE 2
Characteristics of injected microbial consortium in CF4 (mean ± SD)

| | | | | Disp. Test |
|---|---|---|---|---|
| Strain | Cell Count (cells/ml | pH | OD₆₆₀ | (mm) |
| SM1 | 6.2 × 10⁸ ± 1.5 × 10⁸ | 7.58 ± 0.10 | 4.2 ± 1.2 | 4.9 ± 0.9 |
| SM2 | 1.2 × 10⁹ ± 0.2 × 10⁹ | 7.95 ± 0.33 | 5.0 ± 1.0 | 4.9 ± 1.1 |
| SM3 | 8.5 × 10⁸ ± 3.1 × 10⁸ | 7.43 ± 0.23 | 3.0 ± 0.6 | 4.0 ± 0.9 |
| SM14 | 3.9 × 10⁸ ± 2.4 × 10⁸ | 7.11 ± 0.05 | 2.7 ± 0.1 | 3.1 ± 0.2 |

250 ml/day of bacteria SM1, SM2, SM3, and SM14 in exponential phase were injected and grown according to lag phase. Any oil liberated at this point belongs to the tertiary response. The pack was shut in for 7 days at a constant pressure (60 bar) and temperature (60° C.) and then the pack was flooded with two pack volumes of synthetic brine or until 98% water cut. Samples were taken from the pack daily. Accumulated oil was collected and subjected to further analysis.

### Results:

As shown in FIG. 1, by using this technology in lab experiments, an EOR effect of approximately 15% extra oil recovered compared to continuous water flooding has been obtained.

### EXAMPLE 2

### Laboratory-Scale Model of EOR With BLS of the Invention

Initial preparation of sand pack and aging:

As Example 1

### Secondary Flooding:

Sand pack was flooded with synthetic brine at 60° C. at a flow velocity corresponding to a flux of 33 cm/day (flux: 1×) until water break through. After water break through flux was increased to 2× and pack was flooded with two pack volumes of synthetic brine or until 98% water cut.

### BLS Production:

Two BLS preparations (CF3 and CF5) were prepared as follows:

For CF3, overnight cultures of SM1, SM2 and SM3 were grown as described above. For CF5, overnight cultures of SM1, SM2, SM3 and SM14 were grown as described above. Overnight cultures were used to inoculate cultures containing 0.2% v/v of crude oil (crude oil #1 for CF3 and crude oil #2 for CF5) and these cultures were incubated for 3 days at 60° C. and 200 rev/min. Following 3 days of incubation there was a near total emulsification of oil into the water phase. The cultures were alkaline, and an oil-displacement assay (Example 4) confirmed the presence of BLS (Table 3). The cultures were centrifuged (10,000×g, 30 min) and supernatants pooled in a volume ratio of 1 SM1: 2 SM2: 1 SM3 (CF3) or 1 SM1: 1 SM2: 1 SM3: 1 SM14 (CF5). The pooled supernatant was filtered through a series of filters (20-25 μm filter, 2.5 μm, and sterile 0.45 μm filter) to remove bacteria. This filtered solution was clear, contained BLS and had an alkaline pH (Table 3).

TABLE 3
pH and Circle Test (oil-displacement assay) for bacterial
culture and sterile-filtered BLS solutions

| Preparation | Sample | pH | Circle Test (mm) |
|---|---|---|---|
| CF3 | SM1 | 9.25 | 3.5 |
| | SM2 | 9.41 | 6.5 |
| | SM3 | 9.23 | 4.0 |
| | BLS mixture | 9.29 | 5.0 |
| CF5 - 1^{st} batch | SM1 | 9.33 | 9.5 |
| | SM2 | 9.5 | 7.0 |
| | SM3 | 9.22 | 7.0 |
| | SM14 | 8.98 | 6.0 |
| | BLS mixture | 9.26 | 8.5 |
| CF5 - 2^{nd} batch | SM1 | 9.14 | 8.0 |
| | SM2 | 9.38 | 7.0 |
| | SM3 | 9.51 | 9.0 |
| | SM14 | 8.84 | 8.5 |
| | BLS mixture | 9.24 | 7.5 |

### Tertiary Flooding:

Sand pack was flooded with 1.5 effective pack volumes of BLS preparation at a flux of 1× and then shut in for 8-10 hours at constant pressure (60 bar) and temperature (60° C.). Samples were drawn daily at the beginning and at the end of the core. After shut in, the sand pack was flooded with brine at a flux of 1× until water breakthrough. Flux was increased to 2× after water breakthrough for two pack volumes or until 98% water cut. Accumulated oil was collected and subjected to further analysis.

### Results:

By using this technology in lab experiments, an EOR effect of approximately 5% extra oil recovered compared to continuous water flooding has been obtained

### EXAMPLE 3

### Emulsification Properties of BLS of the Invention

BLS was prepared as described in Example 2. Two pieces of hard rock bitumen were prepared by hammer from a hard rock bitumen source. One was placed in distilled water, the other in the BLS preparation and both were incubated for 8 days at 60° C. and 300 rpm.

As shown in FIG. 2, the BLS preparation was able to completely emulsify the oil within the hard rock bitumen whereas distilled water had no effect.

### EXAMPLE 4

### BLS Testing Protocols

### Oil Displacement Assay

10 μl crude oil is added to the surface of 40 ml distilled water on a Petri dish and the allowed to spread out in a thin layer. 10 μl of the sample (e.g. culture or culture supernatant) is placed on the centre of the oil layer. BLS is present in the sample if the oil is displaced and a clear zone formed. The diameter of the clearing zone, measured after 30 seconds, will increase with the amount of BLS. Oil displacement may be measured as the displaced area.

### Emulsification Capacity Index (E10).

This assay is described in more detail in Cooper, D. G. and Goldenberg, B. G. (1987), Surface-Active Agents from Two Bacillus Species, Appl Environ Microbiol 53(2): 224-229, and is based on the emulsification capacity of biosurfactants. Equal volumes of sample and a hydrocarbon (e.g. toluene or n-hexadecane) are added to a glass tube and vortexed at high speed for 2 minutes. After 10 minutes the emulsification index E10 is calculated as the ratio expressed as a percentage between the height of the emulsion layer and the total height of the sample hydrocarbon phase.

### Shake Flask Test.

50 ml test samples are added to baffled 250 ml shake flasks containing 0.1 to 0.2 g crude oil. Flasks are incubated at 55° C. for 60 minutes on a rotary shaker (200 rpm). The qualities of the dispersed oil were evaluated visually.

### Hydrocarbon Emulsification Test.

200 μl test sample is placed in a transparent 5 ml glass tube, 50 μl crude oil is added and vortexed for approximately 20 seconds. The quality of the formed emulsion is evaluated visually and scored from 0 (no emulsion) to 3 (oil-in-water emulsion stable for approximately 10 seconds).

### The Drop Collapse Test.

This test was developed by Jain et al. (Jain, D. K., Collins-Thompson, D. L., Lee, H., and Trevors J. T. (1991), A drop-collapsing test for screening surfactant-producing microorganisms, J Microbiol Methods 13(4): 271-279)) and refined by among others Bodour and Miller-Maier (Bodour, A. A. and Miller-Maier R. M. (1998) Application of a modified drop-collapse technique for surfactant quantitation and screening of biosurfactant-producing microorganisms, J Microbiol Methods 32: 273-280).

The assay is performed in the lid of a 96-well plate. The lid has circular wells and crude oil (2 μl) is added to each of these wells and allowed to spread out and coat the well. The oil is allowed to equilibrate at room temperature overnight. Aliquots (5 μl) of sample are placed into the centre of the oil coated wells and the drop observed after 1 minute. If the drop remains beaded the test is scored as negative, if the drop collapses the result is scored positive. The test may be used qualitatively, it is however possible to score quantitatively by measuring the diameter of the drop after 1 minute.

### EXAMPLE 5

### BLS Testing in Practice

Four different methods were used to determine the presence of BLS activity (biosurfactant activity) in two large scale fermentations (SM1 and SM14, and SM1, SM2 and SM14, respectively).

All methods are simple and relatively rapid to carry out. The drop collapse and oil spreading methods are both an indirect measurement of surface/interfacial tension activity of biosurfactants. They are considered to be reliable methods for an initial confirmation of the presence or absence of surface active components. An emulsification assay was carried out to evaluate the capacity to produce a stable emulsion layer when mixing a hydrophobic compound into an aqueous sample. In addition, as the most evident effect of BLS activity on heavy oils are observed in shake flask with cultures growing on medium and heavy oils, a shake flask assay was developed in order to visually evaluate the effect of BLS activity.

As the samples were collected at different pHs (pH increases during growth) all assays were performed at two pHs, the pH of the sample at sampling time and at an adjusted standard pH. Previous experience with BLS indicates that the activity is closely associated with high pH, thus pH 9.3 was selected as the standard pH used for comparing the BLS activity of different samples. All assays were performed using cell free culture broth, thus only the presence of extracellular surfactants will be proven. Some bacterial cells have high cell hydrophobicity, but do not produce any biosurfactants. If the observed effects on the heavy oil during the fermentations are caused by such hydrophobic bacteria, tests using these methods will return negative results.

### Fermentation Set Up:

Two large scale fermentations using hyperthermophilic consortium for bioconversion of oil have been carried out using a 300 L fermenter with an effective volume of 180-220 litre (Fermentation 1) and 180-210 L (Fermentation 2) at 55° C. and without pH control. Media used as described in Table 4.

TABLE 4
media for large scale fermentation

| Components | g/l |
|---|---|
| Oil | 1.8 |
| Na-acetate | 10 |
| NH₄NO₃ | 3.4 |
| (NH₄)₂SO₄ | 0.4 |
| Na₂HPO₄•2H₂O | 3.06 |
| KH₂PO₄ | 1.52 |
| MgSO₄•7H₂O | 0.4 |
| CaCl₂•2H₂O | 0.05 |
| NaCl | 10 |
| Yeast extract (Oxoid) | 2 |
| FeSO₄•7H₂O | 0.005 |
| ZnSO₄•7H₂O | 0.00044 |
| CuSO₄•5H₂O | 0.00029 |
| MnSO₄•H₂O | 0.00015 |
| Water | 1000 |

After fermentations the cell cultures were separated by centrifugation in three main phases: top fraction oil, a mixture of the cell mass and oil as bottom fraction, and a supernatant water fraction with suspended oil and containing the biosurfactant like substance (BLS). The supernatant fraction was filtered to get rid of the oil particles and further concentrated by water evaporation. The different oil fractions and bacterial cells after centrifugation were separated and stored in refrigerated conditions.

The main differences between these fermentations are given in Table 5 below.

TABLE 5
Summary of the two large scale fermentations performed

| Fermen- | | | Antifoam | Centrifu- | | Concen- |
|---|---|---|---|---|---|---|
| tation no | Strains | Aerobisity | added | gation | Filtration | tration |
| 1 | SM1 + SM14 | Aerobic | no | batch | yes | yes |
| 2 | SM1 + SM14 + SM2 | Aerobic ^{a)} | yes | batch | yes | yes |
| | | Anaerobic | | | | |

^{a)} Aerobic from 0 to 11 h, then anaerobic.

### Fermentation 1 (SM1 and SM2—Aerobic Fermentation With 0.2% v/v Heavy Oil)

The initial agitation was low (160 rpm) and an immediate reduction in dissolved oxygen (DO) was observed. At a DO of approximately 10-15%, the agitation rate was increased to 300 rpm and kept at this value throughout the fermentation. An immediate increase in DO was observed. The initial specific growth rate was high, estimated to 1.5 h⁻¹ from OD measurements, and the metabolic activity reached its maximum value at ˜5 hour after inoculation as shown by both the oxygen uptake rate (OUR) and the carbon dioxide evolution rate (CER). The cell mass, measured as optical density at 660 nm, reached its maximum at ˜10 hours and was relatively constant throughout the rest of the fermentation. The pH increased to 7.5 at the time of maximum metabolic activity and further increased to 9 towards the end of fermentation. The growth measured by OD increased until 11 hours, and then decreased towards the end.

### Fermentation 2 (SM1, SM2 and SM14—Starting Aerobic for Then Developing With Anaerobic Fermentation With 0.2% v/v Heavy Oil, Acetate Added During Fermentation)

Fermentation 2 was carried out with a consortium consisting of two anaerobe strains (SM1 and SM14) and an aerobe strain (SM2). The time course of fermentation 2 was quite similar to fermentation 1 for the logged parameters until 11 h. However, increasing foam was generated during the fermentation, and addition of antifoam was necessary several times.

For this second test the plan for obtaining a higher cell concentration was by fed-batch addition of acetate when the initial added acetate was consumed. Laboratory fermentation tests had shown that strain SM2 could be grown to higher cell concentrations. However, the growth in the second pilot fermentation seemed to be similar to the first one, and the cell mass did not seem to increase. Testing another strategy by adjusting the pH to obtain a restart of the growth was tried. The pH was reduced (after the first harvesting batch) to see if the growth could be restarted again. However, the pH was not controlled, and a pH increase after the acid (HCI) addition was observed. An increase in cell mass was observed, but much smaller than expected. It cannot be concluded that this increase was caused by re-growth after the pH adjustment. In addition, due to intensive foaming at approximately 13 h, the air flow through the fermenter was stopped, and only head space air was supplied for the remaining fermentation period.

### Drop Collapse Test

Samples were taken at 11 and 10 hours (batch 1, Fermentation 1 and 2) were positive for drop collapse activity. Initial testing of samples taken earlier in the fermentation were negative. After 6 hours a faint but positive BLS activity was observed. This indicates that the production of biosurfactants started at some point around 6 hours after inoculation.

### Oil Displacement Test

Comparing the batch samples at pH 9.3 shows that the two batches from Fermentation 2 had higher oil displacement activity than the equivalent batches from Fermentation 1 (Table 6) and, for both fermentations, the second batch sample showed higher activity than the first sample. The main difference between Fermentation 1 and 2 is that strain SM2 was used in Fermentation 2 in addition to SM1 and SM14. Also, unlike Fermentation 1 the last part of the Fermentation 2 fermentation was carried out close to, or under anaerobic conditions, as the air was supplied only to the headspace of the fermenter. Strain SM2 is known to be a good BLS-producer, but it is not able to grow under anaerobic conditions (that is NO₃-reduction). It is possible that the three strains together (Fermentation 2) are better BLS producers than only SM1 and SM14 (Fermentation 1). In our experience strain SM1 and SM14 together seems to be good BLS producers.

TABLE 6
Relative BLS activity determined by the oil
displacement test using Zuata oil.

| Fermentation | Sample no | Oil displacement (mm²) |
|---|---|---|
| Fermentation 1 | Batch 1 pH = 8.84 | 47 |
| | Batch 1 pH = 9.3 | 44 |
| | Batch 2 pH = 9.3 | 133 |
| Fermentation 2 | Batch 1 pH = 8.82 | 113 |
| | Batch 1 pH = 9.3 | 147 |
| | Batch 2 pH = 8.18 | 111 |
| | Batch 2 pH = 9.3 | 161 |

Emulsification capacity test: To confirm the production of BLS an emulsion capacity test was used. The test coincides with the oil displacement test. Both batch samples from Fermentation 2 showed better emulsification activity than samples from Fermentation 1, thus the degree of emulsification was higher in Fermentation 2 samples (Table 7). Also, the stability and density of the emulsified layer was better in the Fermentation 2 samples (FIG. 4).

TABLE 7
Relative BLS activity determined by the
n-hexadecane emulsification test.

| Fermentation | Sample no | Degree of emulsification (%) |
|---|---|---|
| Fermentation 1 | Batch 1 pH = 8.84 | 14.3 |
| | Batch 1 pH = 9.3 | 17.2 |
| | Batch 2 pH = 9.3 | 11.0 |
| Fermentation 2 | Batch 1 pH = 8.82 | 10.3 |
| | Batch 1 pH = 9.3 | 25.0 |
| | Batch 2 pH = 8.18 | 18.5 |
| | Batch 2 pH = 9.3 | 31.0 |

### Testing BLS Activity in Shake Flasks:

Testing the ability of the produced BLS to disperse oil in a shake flask test confirmed the results from the oil displacement and the emulsification capacity tests. Batch samples from Fermentation 2 gave generally better dispersion of the heavy oil than samples from Fermentation 1, and the second batch samples gave much better dispersion of the oil than the first one. Here, however, the difference between Fermentation 1 and Fermentation 2 was relatively small.

In summary, all four methods used to determine BLS activity gave congruent results; all batch samples from Fermentation 2 showed higher surface activity and emulsification activity than the equivalent samples from Fermentation 1. Also, for both Fermentations 1 and 2 the second batch sample was better than the first sample (Table 7). The combination of strain SM2 to SM1 with SM14 in Fermentation 2 may possibly explain the difference in BLS activity in the two fermentations. The effect of mixed aerobic/anaerobic fermentation conditions may have had a positive influence on the emulsification activity.

### EXAMPLE 6

### Growth Parameters

### Introduction—Materials and Methods

A series of growth experiments were conducted on strains SM1-3 and SM5-9 to establish, inter alia, nutrient usage, optimum pH, salt and temperature conditions and tolerances thereof. The results are provided in Table 8.

All tests were carried out in 96 well plates (deep well and ordinary) and in shake flasks using standard RMMAc medium as basic medium with appropriate modification to allow testing of each nutrient/condition. Test incubations typically lasted 3 days, although this was extended for some set-ups in order to acquire data for the more extreme conditions such as high and low pH, salt and temperature.

Growth was determined by measuring optical density (OD₆₆₀) at 660 nm of a sample of the growth medium using a Spectramax Plus (Molecular Devices). Growth was registered as positive when OD₆₆₀ 0.1 (when measured in 96-well plates with 200 μl culture) indicating a cell dry mass greater than 0.1 g/l.

TABLE 8
Nutrient and growth conditions characteristics of strains SM1-3 and SM5-9.

| | SM1 | SM2 | SM3 | SM5 | SM6 | SM7 | SM8 | SM9 |
|---|---|---|---|---|---|---|---|---|
| Accession Number | 15010601 | 15010602 | 15010603 | 15010604 | 15010605 | 15010606 | 15010607 | 15010608 |
| (ECACC) | | | | | | | | |
| Closest species match | Geobacillus | Aeribacillus | Aeribacillus | Aeribacillus | Aeribacillus | Aeribacillus | Aeribacillus | Aeribacillus |
| by 16s rRNA sequence | toebii | pallidus¹ | pallidus | pallidus | pallidus | pallidus | pallidus | pallidus |
| comparison | | | | | | | | |
| Biosurfactant | ✓ | ✓ | ✓ | ✓ | ✓ | ✓ | ✓ | ✓ |
| production (data not | | | | | | | | |
| shown) | | | | | | | | |
| Utilization of: | | | | | | | | |
| Na-acetate | ++ | ++ | ++ | ++ | ++ | ++ | ++ | ++ |
| Na-acetate w/heavy oil | ++ | ++ | ++ | ++ | ++ | ++ | ++ | ++ |
| (Zuata) | | | | | | | | |
| Glucose | + | + | + | + | + | + | + | + |
| Glycerol | + | + | (+) | + | + | + | + | + |
| Hexadecane | + | + | (+) | + | + | + | + | + |
| Heavy oil as sole C- | | | | | | | | |
| source: | | | | | | | | |
| Bressay | + | + | + | + | + | + | + | + |
| Peregrino | + | ++ | + | ++ | ++ | ++ | ++ | + |
| Zuata (new batch) | + | + | ++ | ++ | ++ | ++ | ++ | + |
| Zuata (old batch) | ++ | ++ | + | + | + | + | + | ++ |
| N-source: | | | | | | | | |
| Ammonium | ++ | ++ | ++ | ++ | ++ | ++ | ++ | ++ |
| Nitrate | + | + | + | + | + | + | + | + |
| Complex medium | | | | | | | | |
| components/vitamins: | | | | | | | | |
| Defined w/vitamins | (+) | (+) | + | (+) | (+) | + | + | (+) |
| Yeast extract | + | + | + | + | + | + | + | + |
| Yeast | + | + | (+) | + | + | + | + | + |
| extract/peptone/trypton | | | | | | | | |
| Casamino acids | (+) | − | − | − | (+) | − | (+) | (+) |
| Yeast | ++ | ++ | ++ | ++ | ++ | ++ | ++ | ++ |
| extract/Casamino acids | | | | | | | | |
| Trace minerals (TMS): | | | | | | | | |
| Growth wo/TMS | + | + | + | + | ND | ND | ND | ND |
| pH | | | | | | | | |
| pH range | 6-9 | 6-9 | 6-9 | 6-7 | 6-9 | 6.5-9 | 6-9 | 6-9 |
| Optimum pH | 6.5-7 | 6.5 | 6.5 | 6.5-7 | 6.5 | 7 | 6.5-7 | 6.5-7 |
| Salt (NaCl): | | | | | | | | |
| Range² (%, w/v) | 0-2.5 | 0-4 | 0-5.5+ | 0-4 | 0-5.5+ | 0-4 | 0-5.5+ | 1-4 |
| Optimum (%, w/v) | 1-2 | 1-4 | 0-5.5 | 1-2 | 0-5.5 | 1-4 | 0-5.5 | 1-3 |
| Temperature: | | | | | | | | |
| Range³ (° C.) | 50-70 | 40-60 | 40-60 | 40-60 | 40-60 | 40-60 | 40-70 | 40-60 |
| Optimum (° C.) | 55 | 50-55 | 50-55 | 50 | 50-55 | 55 | 55-60 | 55 |
| Anoxic conditions: | | | | | | | | |
| Fermentation of | + | + | + | + | + | + | + | + |
| glucose | | | | | | | | |
| Nitrate reduction | + | − | − | − | − | − | − | − |

Characteristics are scored as ++ very good growth, + fair to good growth, (+) poor growth, − no growth observed and ND not determined.
The range and optimum values are given for the physical parameters (salt, pH).
¹Reclassified from Geobacillus pallidus
²Range tested (% w/v): 0, 1.0, 2.5, 4.0, 5.0, 7.5
³Range tested (° C.): 40, 50, 55, 60, 70, 80
⁴Range tested: 5.5, 6.0, 6.5, 7.0, 7.5, 8.0, 8.5, 9.0

TABLE 9
Growth on heavy oils (1%) as sole C-source.

| Strain | Bressay | Peregrino | Zuata (new batch) | Zuata (old batch) |
|---|---|---|---|---|
| SM1 | ++ | +++ | +++ | ++++ |
| SM2 | ++ | +++ | ++ | +++ |
| SM3 | ++ | ++ | +++++ | ++ |
| SM5 | ++ | +++++ | ++++ | +++ |
| SM6 | ++ | +++++ | ++++ | ++ |
| SM7 | ++ | +++++ | +++++ | +++ |
| SM8 | ++ | +++ | +++ | ++ |
| SM9 | ++ | ++ | ++ | +++ |

Growth is scored as 0: no growth, +: OD₆₆₀ <0.1, ++: OD₆₆₀ between 0.1-0.25, +++: OD₆₆₀ between 0.25-0.5, ++++: OD₆₆₀ between 0.5-1 and +++++: OD₆₆₀ >1.

TABLE 10
Anaerobic growth at fermentative and nitrate reducing conditions.

| Growth | | | | | | | | | |
|---|---|---|---|---|---|---|---|---|---|
| condi- | | | | | | | | | |
| tion | SM1 | SM2 | SM3 | SM5 | SM6 | SM7 | SM8 | SM9 | SM14 |
| Fermen- | + | + | + | + | + | + | + | + | + |
| tative | | | | | | | | | |
| growth | | | | | | | | | |
| Nitrate | + | − | − | − | − | − | − | − | + |
| reduc- | | | | | | | | | |
| tion | | | | | | | | | |

+ and − denote positive growth and no growth respectively.

### Results and Discussion

A series of experiments have been carried out in order to characterise SM1-3 and SM 5-9 strains.

Carbon source and complex media components: The optimum growth requirements are quite similar for the various strains. The growth was for all strains better on acetate than on glucose; however, the growth on glucose was in the range of good to very good. Opposed to this, growth on glycerol and hexadecane was fair to poor. Addition of Zuata heavy oil (1%, old batch) to the growth medium containing acetate did not restrain growth in any way. Growth on a defined media with acetate as carbon source and with vitamins added was in the fair to poor range.

Physical parameters (pH, salt, temperature): Except for SM5, growth occurred between pH 6-9 with a growth optimum in the range of pH 6.5-7. Growth at high pH (above pH 8) was slow, however given time to adapt all except for SM5 was able to grow at pH up to pH 9. The pH range for SM5 was narrower (pH 6-7) but given time to adapt SM5 was as the only strain able to grow at pH 5.5.

Growth in the presence of salt was observed for all strains. The range was however much wider for SM2, SM3 and SM5-9 (all A. pallidus as closest sequence match) than what was observed for SM1 (G. toebii as closest sequence match). SM3, SM6 and SM8 grew all equally well throughout the tested salt range (0 to 5.5 NaCl). The optimum salt concentration that coincided for all strains was 1-2%.

The selected strains grew well from 50 to 60° C. SM1 did not grow below 50° C. and except for SM5 the growth at 40° C. was quite poor. SM5 grew equally well in from 40 to 60° C. Both SM1 and SM8 were able to grow, however quite poorly, at 70° C. The optimum temperature that coincided for all strains was 55° C.

Trace minerals: The trace mineral solution used in the growth media comprises a total of 17 different trace minerals and is a mixture of standard solutions used in our laboratory. Omitting trace minerals in small scale cultivations (shake flasks) had little effect on growth and cell yield.

Growth on heavy oil: Growth on heavy oil as sole carbon source was tested with MM-medium supplemented with 1% heavy oil (Tables 8 and 9). All strains were able to grow on the tested heavy oils as sole carbon source. Growth on Peregrino heavy oil was very good for all and was the heavy oil that gave the highest cell yield for SM5, SM6, and SM8. SM2 and SM7 grew equally well on both Peregrino and Zuata (SM2 old batch and SM7 new batch) while SM1 and SM9 grew better on Zuata (old batch) and SM3 on Zuata (new batch). SM1, SM3, SM5, SM6 and SM7 grew very well utilizing heavy oil as sole carbon source, SM2, SM8 and SM9 showed somewhat poorer growth on the heavy oils. For all strains growth on Bressay heavy oil was quite poor and tended to be in the lower part of the given range.

Growth at anaerobic conditions: The various strains were tested for their ability to grow at anaerobic conditions by fermenting glucose and on a nitrate reducing media using nitrate as the final electron acceptor instead of oxygen. The microorganisms ability to grow and function at anaerobically (anoxic conditions) is may be an important quality if the microorganisms are going to be used in subterranean oil reservoirs for increased oil recovery. The experiments underlying Table 10 were carried out in the presence and absence of heavy oil added to the growth media.

While all strains were able to ferment glucose in anaerobic conditions, only SM1 and SM14 were able to carry out anaerobic respiration using nitrate as the terminal electron acceptor (Tables 8 and 10). The growth was rather slow and poor compared to growth at aerobic conditions (results not shown). The presence or absence of heavy oil did not influence the growth. It is possible that adapting the strains and optimizing the conditions for growth at anaerobic conditions will increase both the growth rate and the yield.

In conclusion: As can be seen from this Example, strains SM1-3 and SM5-9 share many attributes and in particular those which are indicative of a utility in MEOR, bioremediation and biosurfactant production as already shown for SM1-3 and SM14 in Examples 1 to 4.

1. An isolated bacterial strain selected from the group of bacterial strains consisting of:
(i) the bacterial strain deposited under accession number ECACC 15010609;
(ii) the bacterial strain deposited under accession number ECACC 15010601;
(iii) the bacterial strain deposited under accession number ECACC 15010602;
(iv) the bacterial strain deposited under accession number ECACC 15010603;
(v) the bacterial strain deposited under accession number ECACC 15010604;
(vi) the bacterial strain deposited under accession number ECACC 15010605;
(vii) the bacterial strain deposited under accession number ECACC 15010606;
(viii) the bacterial strain deposited under accession number ECACC 15010607;
(ix) the bacterial strain deposited under accession number ECACC 15010608; and
(x) a bacterial strain having all the identifying characteristics of one or more of strains (i) to (ix).

2. A combined preparation of bacterial strains, said preparation comprising two or more bacterial strains selected from the group defined in claim 1.

3. The combined preparation of claim 2, wherein said preparation comprises at least ECACC 15010601, ECACC 15010602, ECACC 15010603 and ECACC 15010609 and optionally one or more of strains (v)-(x).

4. The combined preparation of claim 2, wherein said preparation comprises at least ECACC 15010601, ECACC 15010602, and ECACC 15010609 and optionally one or more of strains (iv)-(x).

5. A composition comprising one or more bacterial strains selected from the group defined in claim 1 and a suitable carrier.

6. A method of treating an oil reservoir, said method comprising introducing one or more bacterial strains selected from the group defined in claim 1 to said reservoir.

7. The method of claim 6 wherein said reservoir
(i) is in a secondary stage of oil recovery, preferably at the point of displacement fluid breakthrough or at the point at which at least 0.10 pore volumes (PV) of displacement fluid has been injected into the reservoir; or
(ii) has undergone a secondary stage of oil recovery.

8. The method of claim 6 wherein said reservoir contains light crude oil, heavy crude oil, or oil of intermediate weight.

9. The method of claim 8 wherein said reservoir contains bitumen/asphalt.

10. A method of bioremediation, said method comprising contacting one or more bacterial strains selected from the group defined in claim 1 with a site or a material in need of bioremediation.

11. The method of claim 10, wherein said site or material in need of bioremediation is contaminated with hydrocarbons, preferably crude oil, refined petroleum products, PAHs and alkanes, and/or heavy metals.

12. The method of claim 6, wherein said one or more strains are ECACC 15010601, ECACC 15010602, and ECACC 15010609 and optionally one or more of strains (iv)-(x).

13. The method of claim 6, wherein said one or more strains are ECACC 15010601, ECACC 15010602 and ECACC 15010603 and optionally one or more of strains (i) or (v)-(x).

14. The method of claim 6, wherein said one or more strains are ECACC 15010601, ECACC 15010602, ECACC 15010603 and ECACC 15010609 and optionally one or more of strains (v)-(x).

15. The method of claim 6, wherein said method further comprises culturing said bacterial strains ex situ and then introducing said cultured bacteria to the reservoir, or contacting said cultured bacteria with the site or material in need of bioremediation.

16. The method of claim 15, wherein said culture has a cell density of 5×10⁸ cells/ml to 5×10⁹ cell s/ml at the point of introduction or contacting.

17. The method of claim 16, wherein said culture is introduced or contacted when the bacteria are in the exponential phase, preferably the late exponential phase of their growth curve.

18. The method of claim 15, wherein the culturing of said bacterial takes place
(i) in the presence of oil obtained from the reservoir and under conditions which allow the bacteria to grow and to use the oil as a carbon source and/or to produce a biosurfactant-like substance, or
(ii) in the presence of contaminants from the site or a material in need of bioremediation and under conditions which allow the bacteria to grow and to use the contaminants as a carbon source and/or to produce a biosurfactant-like substance.

19. A method for the production of a biosurfactant-like substance (BLS), said method comprising culturing one or more bacterial strains selected from the group defined in claim 1 in the presence of a hydrocarbon source.

20. The method of claim 19, wherein said hydrocarbon source is a source of alkanes and/or polycyclic aromatic hydrocarbons, preferably crude oil.

21. The method of claim 19, wherein said one or more strains are ECACC 15010601 and ECACC 15010602 and optionally one or more of strains (i) or (iv)-(x).

22. The method of claim 21, wherein said one or more strains are ECACC 15010601, ECACC 15010602, and ECACC 15010609 and optionally one or more of strains (iv) to (x).

23. The method of claim 19, wherein said culture has a cell density of 5×10⁸ cells/m1 to 5×10⁹ cells/ml.

24. The method of claim 23, wherein said culture is allowed to continue for period of time in the stationary phase of its growth curve.

25. The method of claim 19 wherein said method comprises harvesting the culture supernatant.

26. The method of claim 25, wherein two or more bacterial strains are selected and one or more of said two or more strains are cultured separately from the others and said harvested culture supernatants are combined.

27. The method of claim 25 wherein said harvested culture supernatant is substantially free of bacterial cells and/or cell debris.

28. The method of claim 25, wherein said method comprises a step of concentrating the BLS fraction of the harvested culture supernatant, preferably by chromatography, dialysis, filtration, precipitation, distillation or evaporation.

29. The method of claim 19, wherein said BLS has emulsifying activity, surface/interfacial activity and/or oil displacement activity against at least one hydrocarbon substrate, preferably crude oil.

30. A biosurfactant-like substance, wherein said substance is obtained or obtainable from a method as defined in claim 19.

31. A method of enhanced oil recovery (EOR), said method comprising introducing a BLS as defined in claim 30 to an oil reservoir.

32. The method of claim 31 wherein said reservoir has undergone a secondary stage of oil recovery.

33. The method of claim 31 wherein said reservoir contains light crude oil, heavy crude oil, or oil of intermediate weight.

34. The method of claim 33 wherein said reservoir contains bitumen/asphalt.

35. A method of environmental remediation, said method comprising contacting a BLS as defined in claim 30 with a site or a material in need of environmental remediation.

36. The method of claim 35, wherein said site or material in need of bioremediation is contaminated with hydrocarbons, preferably crude oil, refined petroleum products, PAHs and alkanes, and/or heavy metals.
